(19) United States
(12) Patent Application Publication
(10) Pub. No.: US 2012/0082968 A1
(43) Pub. Date: Apr. 5, 2012

(54) Journal System

(76) Inventors: Catherine D. Dowdell, Caledonia, WI (US); Kristina J. Genslak, Racine, WI (US); John R. Weaver, Waukesha, WI (US); David Ratfelders, Mequon, WI (US); Lillard Wells Culver, III, Mequon, WI (US); James R. Crapser, Racine, WI (US)

(21) Appl. No.: 12/896,689

(22) Filed: Oct. 1, 2010

(51) Int. Cl. G09B 19/00

(52) U.S. Cl. 434/236

(57) ABSTRACT

A journal system for promoting a person's personal growth and a method for guiding a journal user to use a journal are provided. The journal system includes a plurality of cards, each card having a writable portion configured to receive an entry from a user and a written content portion. The written content portion includes a prompt to the user and an intention relating to the prompt to facilitate the entry from the user.

### FIELD OF THE INVENTION

The present invention is directed to a journal system and method of guiding journal entries, and more particularly to a journal system and a method of guiding journal entries for promoting a journal user's personal growth.

### BACKGROUND OF THE INVENTION

The demands of contemporary living require constant attention throughout the day. Daily life activities include work, family, socializing and more. The constant juggling of other people's needs in addition to one's own needs leaves little time for one's self. These activities may become detrimental to one's personal growth, for example when the to do lists become too long, the challenges seem insurmountable, concentration or focus is lost due to competing needs, personal fulfillment is lacking or similar issues.

There is a need to make the daily life activities more meaningful and to promote personal growth to facilitate wellness and balance. Daily activities or any life activities can become more meaningful when a person is connected to awareness. A guiding system to help direct one's thoughts toward awareness is beneficial to promote personal growth.

Many people may be unsure about which of the numerous exercises, products, or personal growth systems are best suited to fit their particular needs. Moreover, one exercise or product may be effective on one occasion, but not another occasion, leading a person to be frustrated with their choices and progress in personal growth and abandon the practice altogether. Additionally, because feelings and needs may vary, one may not want to be tied down to a particular exercise, product, or system that is suited for a particular feeling, such as stress.

One way to become more aware is to journal or to write about daily life activities. For new journal users or for users needing some direction to begin journaling, a blank journal page may make the journaling experience too difficult to begin.

What is needed is a journal system for promoting personal growth that provides the user with one or more prompts to facilitate the journaling process. A journal system is needed that guides the journal user by providing an intention for the journal user to consider for the moment when the journal user is being aware, acting to make a journal entry and then applying that intention to reflect on the journal entry to promote personal growth.

### BRIEF SUMMARY

A journal system for promoting a person's personal growth, a method for guiding a journal user to use a journal and a method of manufacturing a journal system are provided. The journal system includes a plurality of cards, each card having a writable portion configured to receive an entry from a user and a written content portion. The written content portion includes a prompt to the user and an intention relating to the prompt to facilitate the entry from the user.

### BRIEF DESCRIPTION OF THE DRAWINGS

FIGS. 1A and 1B are plan views of a card of a journal system in accordance with an embodiment of the present invention;

FIG. 2 illustrates the intentions, the associated symbols and scents of an embodiment of the journal system;

FIGS. 3A and 3B are plan views of a packaging of an embodiment of the journal system;

FIG. 4 is a plan view of a scented card of an embodiment of the journal system;

FIGS. 5A and 5B are plan views of an instruction card of an embodiment of the journal system;

FIGS. 6A-7B are plan views of embodiments of instruction cards of an embodiment of the journal system;

FIG. 8 is a perspective view of a holder in accordance with an embodiment of the journal system;

FIG. 9 is a top view of a base of the holder of an embodiment of the journal system;

FIG. 10 is a top view of a cover of the holder of an embodiment of the journal system;

FIG. 11 is a sectional view of the holder of an embodiment of the journal system;

FIG. 12 is a sectional view of an alternative embodiment of the cover of the holder;

FIG. 13 is an exploded view of the cover of an embodiment of the journal system; and

FIG. 14 is a sectional view of the holder of an embodiment of the journal system.

### DETAILED DESCRIPTION

Embodiments of the invention are described with reference to the drawings in which like elements are referred to by like numerals. The relationship and functioning of the various elements of these embodiments are better understood by the following detailed description. However, the embodiments of this invention are not limited to the embodiments illustrated in the drawings. It should be understood that the drawings are not to scale, and in certain instances details have been omitted which are not necessary for an understanding of the present invention, such as conventional fabrication and assembly.

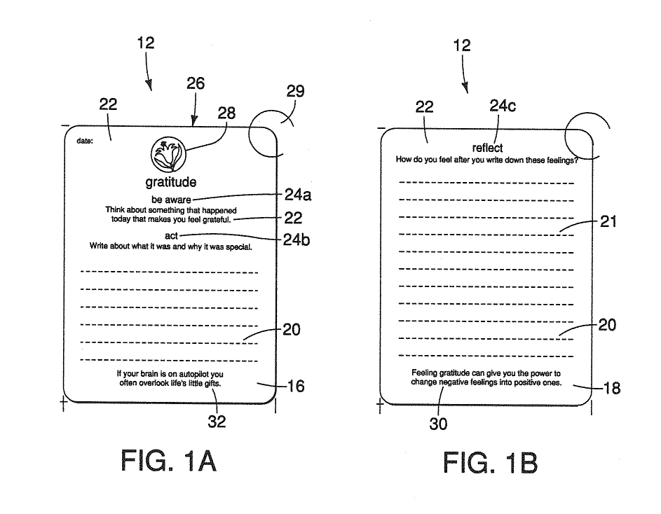

FIGS. 1A and 1B illustrate an embodiment of the journal system 10. The journal system 10 may include one or more cards 12. An exemplary card 12 is illustrated in FIGS. 1A and 1B. As shown, the card 12 may include a first side 16 and a second side 18. One or both of the sides 16, 18 may include a writable portion 20 that is configured to receive one or more entries from a user. The writable portion 20 may include lines 21 or may be open space on the card 12 to receive user entries. One or both sides 16, 18 of the card 12 may also include a written content portion 22. The card 12 may be any size and shape. In some embodiments, the card 12 may be sized to be held in the hand of a user. By way of non-limiting example, the card 12 may be about 3×4 inches (7.6×10.2 cm), about 3×5 inches (7.6×12.7 cm) or about 4×6 inches (10.2×15.2 cm). Other sizes for the card 12 may also be used.

As shown in FIGS. 1A and 1B, the written content portion 22 may include a prompt 24 to the user to assist the user in making an entry onto the writable portion 20. The card 12 may include one or more prompts 24 instructing the user to “be aware”, “act” and/or “reflect.” By way of non-limiting example, the “be aware” prompt 24a may instruct the user to think about a thought or an event. The “act” prompt 24b may instruct the user to write about the thought or the event that the user has become aware of based on the “be aware” prompt 24a. The “reflect” prompt 24c may direct the user to reflect on the feelings the act brought about. The user may enter the reflection by writing about the reflection on the writable portion 20 of the card 12.

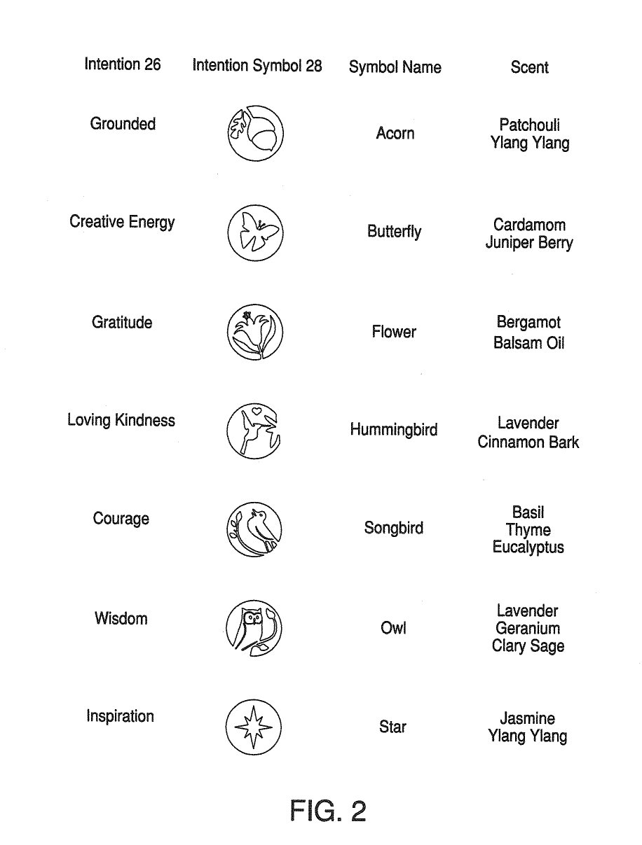

The journal system 10 may include a plurality of cards 12 wherein the plurality of cards guide the user by including an intention 26. The intention 26 is based on a determination to act in a certain way. The intention 26 is informed by western psychology and inspired by Buddhist teachings and includes, but is not limited to the following: grounded, creative energy, gratitude, loving kindness, courage, wisdom, and inspiration. Each intention 26 may have a symbol and/or a scent associated with the intention 26. In some embodiments, each intention 26 may have a color associated with the intention 26. The symbols, scents and colors for each intention 26 in this embodiment are shown in FIG. 2. The grounded intention may be symbolized by the acorn, the scent associated with the grounded intention may include patchouli and ylang ylang and the color may be burgundy. The creative energy intention may be symbolized by the butterfly, the scent associated with the creative intention may include cardamom and juniper berry and the color may be orange. The gratitude intention may be symbolized by the flower, the associated scent may include bergamot and balsam oil and the color may be green. The loving kindness intention may be symbolized by the hummingbird, the associated scent may include lavender and cinnamon bark and the color may be pink. The courage intention may be symbolized by the song bird, the associated scent may include basil, thyme and eucalyptus and the color may be blue. The wisdom intention may be symbolized by the owl, the associated scent may include lavender, geranium and clary sage and the color may be purple. The inspiration intention may be symbolized by the star, the associated scent may include jasmine and ylang ylang and the color may be white. Additional intentions 26 may also be used with the journal system 10 and may include their own symbol, scent and color.

Each plurality of cards 12 may guide the user by including one intention 26. For example, the journal system 10 may include a plurality of cards 12 including grounded intention 26 to guide the user. Another plurality of cards 12 may include the gratitude intention 26 and other cards 12 may include one each of the other intentions 26 shown in FIG. 2. FIGS. 1A and 1B are non-limiting examples and illustrate the card 12 including the gratitude intention 26. As shown in FIG. 1A, a symbol 28 is included on the card 12 and illustrates the gratitude symbol 28. The word “gratitude” may also be included on the card 12 as part of the written content portion 22. A message 30 relating to the specific intention 26 may also be included on each card 12. Each of the plurality of cards 12 including the specific intention 26 may be provided together in a packaging 40 as described in more detail below. The written content portion 22 may also include a quotation or inspirational message 32. Each card 12 may include a different quotation or inspirational message 32. The plurality of cards 12 may also include written content portion 22 for the date and a writable portion 22 for the user to enter the date upon which the entry is made. In some embodiments, the card 12 may include rounded corners 29.

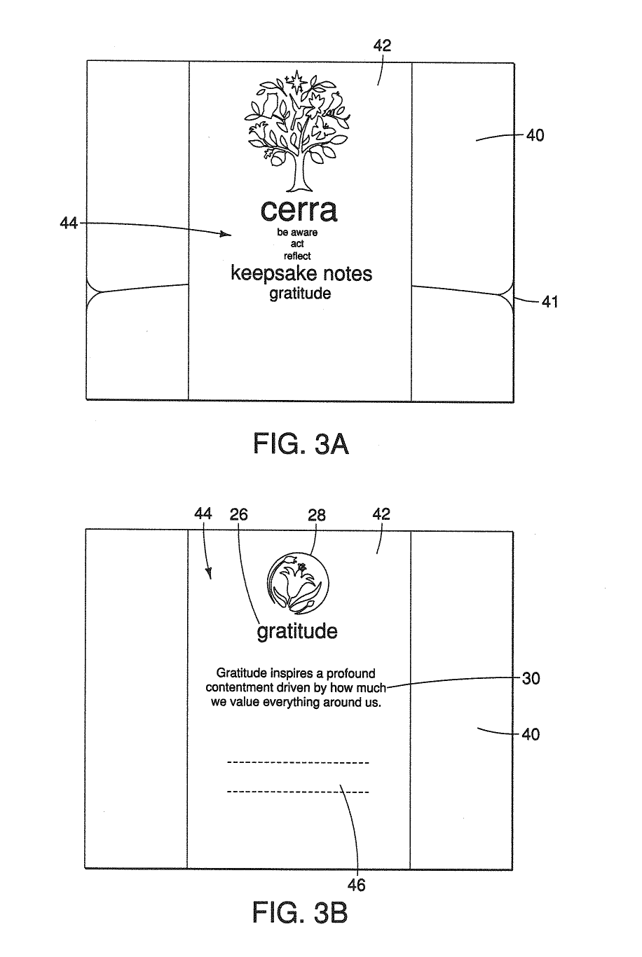

The plurality of cards 12 may be provided in a packaging 40 such as a box or an envelope or the like. The packaging 40 is shown in FIGS. 3A and 3B and is sized and shaped to receive the plurality of cards 12. The packaging 40 itself may include a closure 41, such as a flap so that the packaging 40 is self-closing. The packaging 40 may also include a band 42 slidable over the packaging 40 to secure the cards 12 in the packaging 40. The band 42 may also include a written content portion 44 and a writable portion 46. The written content portion 44 may include one of the intentions 26 on the band 42 to indicate to the user the guided intention 26 of the cards 12 contained within the packaging 40. The symbol 28 and the name of the specific intention 26 and the message 30 relating to the specific intention 26 may also be included in the written content portion 44 of the band 42.

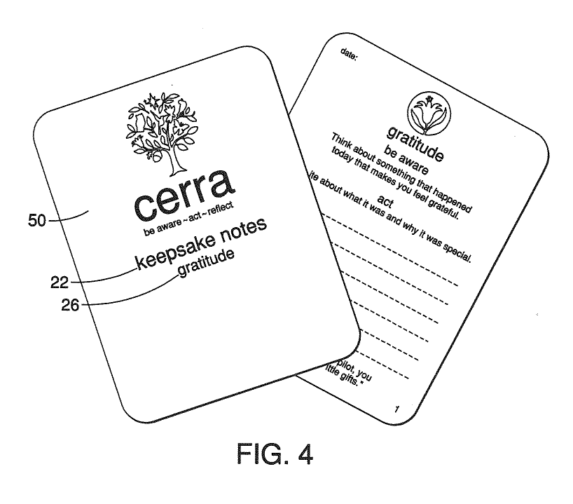

The journal system 10 may also include one or more scented cards 50 as shown in FIG. 4. The scented card 50 may include a written content portion 22. The written content portion 22 indicates one intention 26 that corresponds to the intention 26 on the plurality of cards 12 and on the band 42. The scent on the scented card 50 corresponds to the intention 26 as shown in FIG. 2. The scented card 50 may be positioned on top of the plurality of cards 12 and packaged within a cellophane wrapper (not shown).

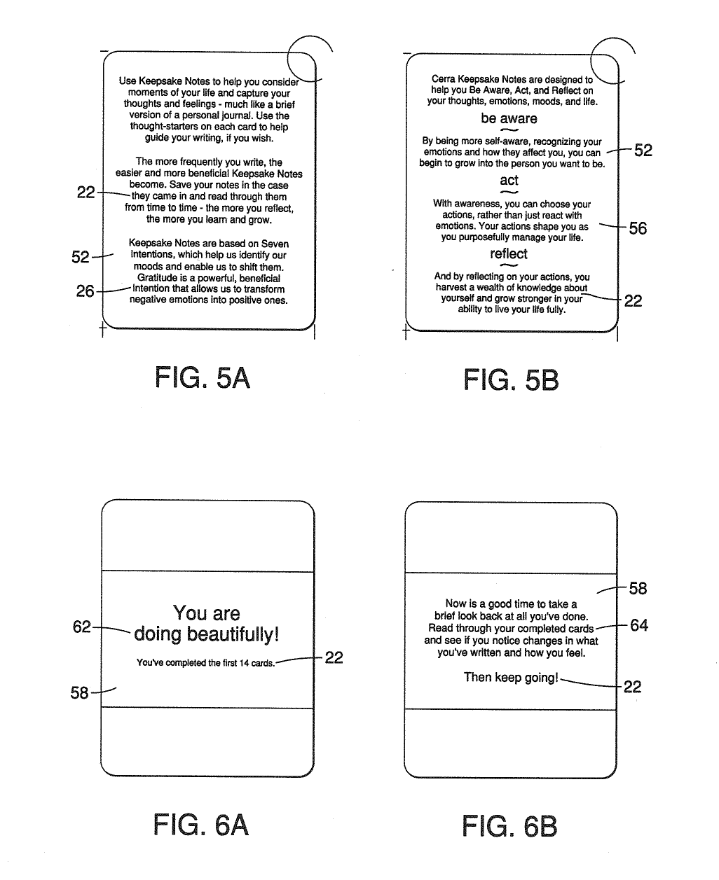

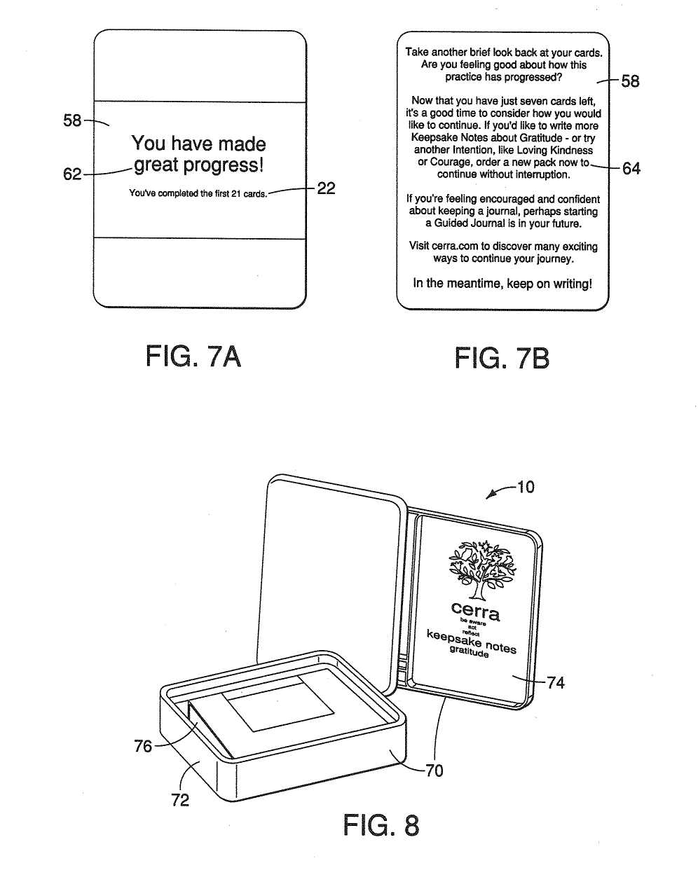

The journal system 10 also may include an instruction card 52 as shown in FIGS. 5A and 5B. The instruction card 52 includes a first side 54 and a second side 56. The first side 54 may include general instructions to the user in the written content portion 22 for helping the user to consider moments and capture thoughts and feelings on the cards 12. The first side 54 may describe a specific intention 26. The second side 56 of the instruction card 52 may include one or more written content portions 22 that include explanations to the user to “be aware,” “act” and “reflect.” Additional instruction cards 58 may also be included with the plurality of the cards 12. By way of non-limiting example, the instruction card 58 shown in FIGS. 6A-7B may be included and positioned after the first fourteen cards 12 and the first twenty-one cards 12 to encourage the user. The card 58 includes a first side 62 and a second side 64. The first side 62 may include the written content portion 22 that provides the user with a positive statement. The second side 64 may include instructions to the user to review writable portions 20 that have been completed by the user on the previous cards

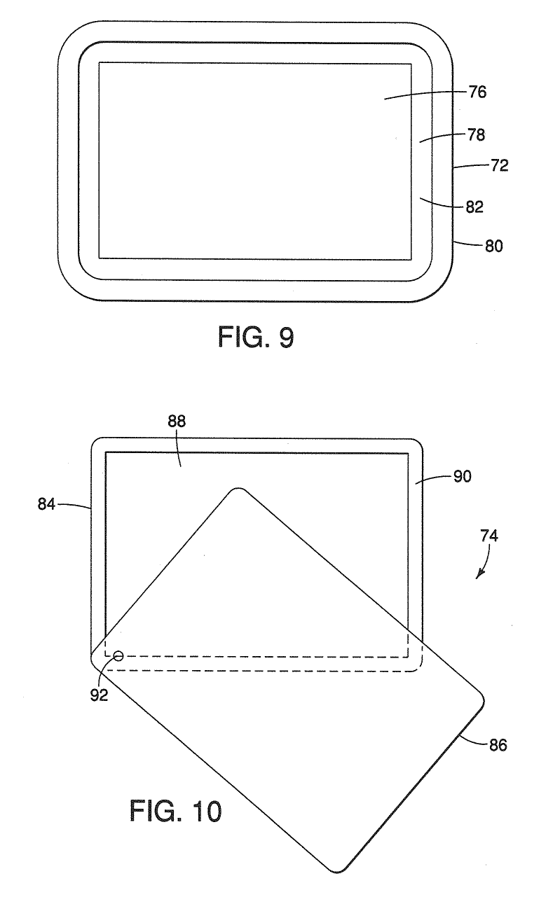

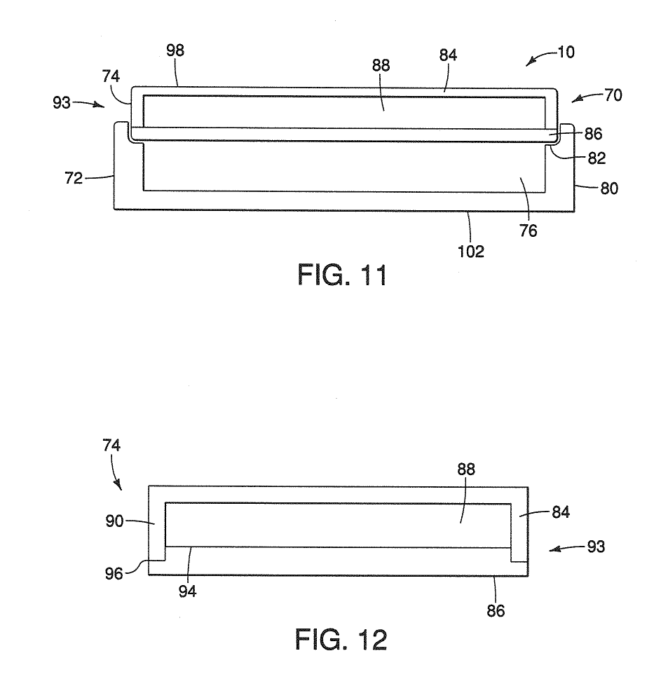

The journal system 10 may also include a holder 70 configured to hold a plurality of cards 12 as shown in FIG. 8. The holder 70 may include a base 72 and a removable cover 74. The base 72 is shown in more detail in FIG. 9. The base 72 includes a base cavity 76 formed therein. The base cavity 76 is sized and shaped to receive the packaging 40 or the plurality of cards 12 without the packaging 40. The base cavity 76 is surrounded by a wall 78 having an exterior periphery 80 and a recessed edge 82 extending inward from the periphery 80 toward the base cavity 76. The recessed edge 82 is shown in a cross-sectional view in FIG. 11.

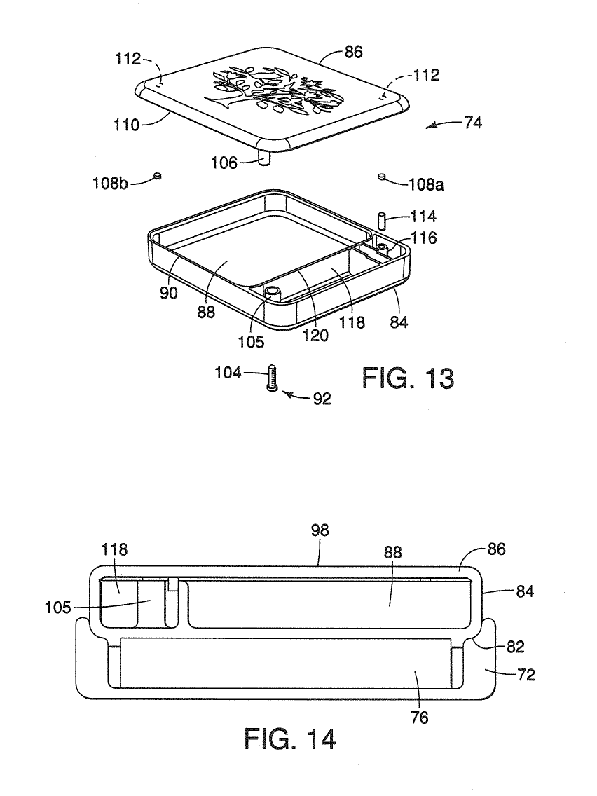

The removable cover 74 is shown in FIGS. 8 and 10-14. The removable cover 74 is sized and shaped to enclose the base cavity 76. As shown in FIGS. 11 and 14, the cover 74 fits within the periphery 80 of the wall 78 and rests on the recessed edge 82. In some embodiments, the cover 74 may fit over the base 72 to enclose the base cavity 76. The cover 74 may include a first portion 84 and a second portion 86 as shown in FIG. 10. The second portion 86 is movable relative to the first portion 84 to enclose a cover cavity 88 formed in the first portion 84. The cover cavity 88 is surrounded by a wall 90. The cover cavity 88 is sized and shaped to receive a plurality of cards 12. In some embodiments, the first portion may include a second cover cavity 118 as shown in FIG. 13. The second cover cavity may be formed by an interior wall 120 extending across the first portion 84 and connected to the wall 90. The second cover cavity 118 may be sized and shaped to receive a writing utensil (not shown). In some embodiments, the second portion 86 is pivotally connected to the first portion 84 by a pivotable connector 92 as shown in FIG. 10. The second portion 84 may be pivoted to expose and reclose the cover cavity 88 and the cards 12 stored therein. The second portion 86 fits close to or against the first portion 84 so that the cards 12 stored in the cover cavity 88 remain within the cover cavity 88 when the second portion 86 is in a closed position 93. As shown in the exploded view in FIG. 13, the pivotable connector 92 may be screw 104 that is mountable in a hollow post 105 in the first portion 84 and connectable to a hollow post 106 on the second portion 86 so the second portion 86 is movable to expose and reclose the cover cavity 88. In some embodiments, the second portion 86 may include one or more magnets 108 positioned on a side 110 of the second portion facing the cover cavity 88 to help hold the second portion 86 in a selected position. The magnets 108 may be positioned in opposite corners 112 of the second portion 86 so that when the second portion 86 is pivoted, the magnet 108a connects with a first portion magnet 114 positioned in a hollow post 116 on first portion 84 when the cover cavity 88 is enclosed. The magnet 108b connects with the first portion magnet 114 when the cover cavity 88 is exposed.

The second portion 86 may also include a raised central portion 94 and a recessed peripheral edge 96 so that the second portion 86 forms a friction fit with the first portion 84 in the closed position 93 as illustrated in FIG. 12. The second portion 86 may also be connected to the first portion 84 by any other mechanism known to one skilled in the art. Preferably, the connection of the first portion 84 to the second portion 86 does not interfere with the positioning of the cover 74 on the recessed edge 82 of the base 72.

As shown in FIG. 11, the second portion 86 of the cover 74 may be positioned against the recessed edge 82 of the base 72 and the first portion 84 extends away from the base 82. In the configuration shown in FIG. 11, the first portion 84 of the cover 72 forms the top 98 of the holder 70 and the base 72 forms the bottom 102 of the holder 70. In some embodiments, the second portion 86 of the cover 74 may be completely enclosed in the wall 80 when the cover 74 is positioned on the recessed edge 82 so that only the first portion 84 and the base 72 are visible and the cover cavity 88 is hidden. The first portion 84 may also be positionable on the recessed edge 82 of the base 72 so that the second portion 86 of the cover 74 forms the top 98 of the holder 70 as shown in FIG. 14. The cover cavity 88 may be exposed when the cover 74 is positioned on the recessed edge 82 and the second portion 86 forms the top 98.

The journal system 10 may be provided to ease the user into the journaling experience. By way of non-limiting example, the specific intention 26 of gratitude will be described. The journaling experience described below may be achieved for any for the seven intentions 26 described in the embodiment above using the journal system 10. The cards 12 may be provided to the user in the packaging 40 with the scented card 50 and the instructions cards 52, 58 also provided in the packaging 40. The scented card 50 includes a specific scent including bergamot and balsam oil to reinforce the specific intention 26 of gratitude on which the user would like to work. The packaging 40 may be stored in the base 72 of the holder 70.

To begin the journaling experience, the user removes the cover 70 from the base 72 and removes the packaging 40 from the base cavity 76 in the base 72. The user removes the band 42 from the packaging 40. The band 42 includes the name of the specific intention 26 gratitude and the symbol 28 on the written content portion 44 of the band 42. The user opens the packaging 40, exposes the scented card 50 and inhales the scent of bergamot and balsam oil. The user reviews the instruction card 52 and selects one card 12. For subsequent uses, the user may select one card 12 without reviewing the instruction card 52. The user reads the instruction “be aware” on the written content portion 22 of the card 12. Next, the user reads the “act” instruction and places a journal entry on the writable portion 20 of the card 12 in response to the “be aware” instruction. The card 12 may be flipped to the second side 18 so the user can read the “reflect” instruction and place a journal entry on the writable portion 20 of the card 12 in response to the “reflect” prompt 24c. At any time during the journaling experience, the user may read the messages 30, 32. Once the user completes the journaling experience for the selected card 12, the user may hide card 12 including the journal entry in the cover cavity 88 of the first portion 84 of the cover 74. The second portion 86 may be moved to enclose the cover cavity 88 and hide the card. The band 42 may be placed over the packaging 40 and the packaging 40 returned to the base cavity 76 in the base 72. The cover 74 may be positioned on the recessed edge 82 of the base 72 with the second portion 86 hidden from sight so that the location of the card 12 with the journal entry is hidden. Alternatively, the cover 74 may be positioned on the recessed edge 82 of the base 72 with the second portion 86 forming the top 98 of the journal system 10 so that the journal user can access the card 12 in the cover cavity 88 when the base 72 and the cover 74 enclose the base cavity 76.

The user may repeat the journaling experience multiple times, each time journaling on a new card 12. The user may also complete a portion of the cards 12 and reach the additional instruction cards 52, 58. The user may review the previous journal entries following review of the instructions on the cards 52, 58 or at any time during the journaling experience.

The journal system 10 may be manufactured using a variety of manufacturing techniques. For example, the base 72 and the cover 74 of the holder 70 may be formed by molding the base 72 and cover 74 such as by injection molding. The cover 74 may be formed in two parts by forming the first portion 84 and forming the cover cavity 88 therein. The second portion 86 may be formed separately from the first portion 84 and then connected to the first portion 88. The second portion 86 may then be connected the first portion 84, for example, by friction fit or by providing a pivotable connector 92 such as the screw 104 and posts 105, 106. The magnets 108 may be secured to the second portion 74 by any method and the magnet 114 may be positioned in the post 116 and secured thereto.

The cards 12 may be made of any suitable material for receiving a written entry from a journal user, for example paper or cardstock. The corners 29 of the cards 12 may be rounded and the written content portion 22 maybe printed on to the cards 12. The scented card 50 may be cut from blotter paper or the like and the appropriate scent added to the card 50. The card 50 and the cards 12 may be packaged together and placed in the base cavity 76 of the base 72. The cover 74 may be positioned on the base 72 to enclose the cards 12 and the card 50 within the base cavity 76 for delivery to the journal user. The cards 12 and the card 50 may also be provided to the journal user separately from the holder 70.

The above Figures and disclosure are intended to be illustrative and not exhaustive. This description will suggest many variations and alternatives to one of ordinary skill in the art. All such variations and alternatives are intended to be encompassed within the scope of the attached claims. Those familiar with the art may recognize other equivalents to the specific embodiments described herein which equivalents are also intended to be encompassed by the attached claims.

1. A journal system for promoting a person's personal growth, the journal system comprising:
a plurality of cards, each card having a writable portion configured to receive an entry from a user and a written content portion to provide a prompt to the user for the entry; and
a holder configured to hold the plurality of cards, the holder comprising:
a base having a base cavity formed therein, the cavity surrounded by a wall, the wall having an exterior periphery and a recessed edge extending inward from the periphery toward the base cavity, the base cavity being sized to receive the plurality of cards; and
a removable cover sized and shaped to fit within the exterior periphery of the base and enclose the base cavity, a portion of the cover positioned on the recessed edge to enclose the base cavity.

2. The journal system of claim 1, wherein the cover further comprises a first portion and a second portion, the first portion having a cover cavity formed therein and the second portion movable relative to the first portion to enclose the cover cavity, the cover cavity being sized to receive the plurality of cards.

3. The journal system of claim 2, wherein the second portion is concealed within the wall of the base when the cover is positioned on the recessed edge.

4. The journal system of claim 2, wherein second portion is pivotally connected to the first portion to move from an open position wherein the cover cavity is exposed and a closed position wherein the cover cavity is closed.

5. The journal system of claim 1, wherein the system further comprises a packaging to receive and enclose the plurality of cards and to fit within the base cavity, the packaging comprising a band for securing the box in a closed configuration, the band identifying an intention.

6. The journal system of claim 1, wherein the written content portion includes one or more prompts comprising “be aware,” “act” or “reflect.”

7. The journal system of claim 1, wherein the written content portion includes an intention comprising grounded, creative energy, gratitude, loving kindness, courage, wisdom or inspiration.

8. A journal system for promoting a person's personal growth, the journal system comprising:
a plurality of cards, each card having a writable portion configured to receive an entry from a user and a written content portion, the written content portion comprising:
a prompt to the user; and
an intention relating to the prompt to facilitate the entry from the user.

9. The journal system of claim 8, wherein the intention comprises grounded, creative energy, gratitude, loving kindness, courage, wisdom or inspiration.

10. The journal system of claim 8, wherein the prompt comprises one or more prompts comprising “be aware,” “act” or “reflect.”

11. The journal system of claim 8, wherein the system further comprises a scented card, each intention comprising a different scent.

12. The journal system of claim 8, wherein the system comprises the plurality of cards wherein the written content portion of the plurality of cards is directed to one intention.

13. The journal system of claim 8, wherein each of the plurality of cards comprises at least one different written content portion.

14. The journal system of claim 8, further comprising an instruction card comprising instructions to review the plurality of cards having user entries in the writable portion.

15. The journal system of claim 8, wherein the plurality of cards comprises a symbol, the symbol specific for the intention.

16. A method of guiding a journal user to use a journal, the method comprising:
providing a card to the journal user;
providing an instruction on the card to be aware of a thought or an event;
providing an instruction on the card to act by making a first journal entry on the card about the thought or the event;
providing an instruction on the card to reflect on the first journal entry;
providing a holder having a cover cavity for storing the card after the journal user makes the first journal entry; and
providing an instruction to the journal user to reread the first journal entry on one or more cards stored in the cover cavity after the user has completed first journal entries on a plurality of cards.

17. The method of claim 16, further comprising providing the instruction to reflect on the first journal entry by making a second journal entry on the card about the reflection on the first journal entry.

18. The method of claim 16, further comprising providing an intention on the card relating to the instruction to be aware to guide the user to the thought or event.

19. The method of claim 16, further comprising providing the card having a written content portion including the instruction to be aware, the instruction to act and the instruction to reflect and a writable portion for the user to make one or journal more entries.
